(19) United States
(12) Patent Application Publication
(10) Pub. No.: US 2020/0082128 A1
(43) Pub. Date: Mar. 12, 2020

(54) SEMICONDUCTOR DEVICE AND COMPUTER SYSTEM

(71) Applicant: RENESAS ELECTRONICS CORPORATION, Tokyo (JP)

(72) Inventor: Daisuke OSHIDA, Tokyo (JP)

(21) Appl. No.: 16/540,841

(22) Filed: Aug. 14, 2019

(30) Foreign Application Priority Data
Sep. 7, 2018 (JP) 2018-167958

(51) Int. Cl. G06F 21/73

(52) U.S. Cl. CPC G06F 21/73

(57) ABSTRACT

A semiconductor device included in a computer system, the semiconductor device comprising an acquiring circuit that acquires irreversible data unique to another semiconductor device, and a detecting circuit that verifies whether the irreversible data of another semiconductor device is inconsistent with previously acquired irreversible data of another semiconductor device and detecting an abnormality of the computer system based on the verification result.

### CROSS-REFERENCE TO RELATED APPLICATIONS

The disclosure of Japanese Patent Application No. 2018-167958 filed on Sep. 7, 2018 including the specification, drawings and abstract is incorporated herein by reference in its entirety.

### BACKGROUND

The present invention relates to a semiconductor device and, for example, the present invention can be suitably used for detecting abnormalities in computer systems.

In recent years, there has been proposed a technique for calculating stress data representing stress data received by an LSI (Large Scale Integration). For example, patent document 1 discloses a technique for calculating stress data of a semiconductor device by counting the oscillation of a ring oscillator having a frequency characteristic proportional to temperature dependence and voltage dependence, since the lifetime of a ring oscillator within a semiconductor device (LSI) depends on voltage and temperature.

### [Patent Document 1]

Japanese Unexamined Publication Laid-Open No. 2018-091804

### SUMMARY

Incidentally, the stress data of the LSI is irreversible data unique to the LSI. However, in the art of Patent Document 1, stress data of an LSI is only used for predicting wear failure of an LSI, and there is a problem that irreversible data unique to an LSI such as stress data cannot be effectively used.

Other objects and novel features will become apparent from the description of this specification and the accompanying drawings.

According to one embodiment, a semiconductor device is a semiconductor device of one of a plurality of semiconductor device included in a computer system. The semiconductor device includes an acquiring circuit for acquiring irreversible data unique to another semiconductor device, and a detecting circuit for reacquiring the data of another semiconductor device acquired most recently, verifying whether the reacquired data is inconsistent with the data of the other semiconductor device acquired most recently, and detecting an anomaly of the computer system based on a result of the verification.

According to the above-mentioned embodiment, it is possible to contribute to the solution of the above-mentioned problem.

### BRIEF DESCRIPTION OF THE DRAWINGS

FIG. 1 shows a configuration example of a computer system according to a first embodiment.

FIG. 2 is a block diagram illustrating a configuration example of a computer pertaining to first embodiment;

FIG. 3 shows examples of stress data tables for first embodiment;

FIG. 4 is a sequence diagram illustrating an example of an operation of exchanging stress data between computers, and an operation in which each computer calculates stress data in a computer system pertaining to first embodiment;

FIG. 5 shows examples of operations to verify stress data in a computer related to first embodiment;

FIG. 6 is a flow diagram illustrating an example of a processing flow;

FIG. 7 is a diagram illustrating an operation example of a computer system according to a first aspect of a second embodiment;

FIG. 8 is a flow diagram illustrating an example of a processing flow in each computer;

FIG. 9 is a diagram illustrating an exemplary configuration of a computer system according to a second aspect of the second embodiment;

FIG. 10 is a sequence diagram illustrating an example of operation when a computer is replaced properly in the computer system according to the second aspect of second embodiment;

FIG. 11 is a diagram illustrating an exemplary configuration of a computer system according to a third aspect of the second embodiment;

FIG. 12 is a sequence diagram illustrating an example of operation when a computer is replaced properly in the computer system according to the third aspect of second embodiment;

FIG. 13 shows an example of the expected value of the sensor value and the tolerance value of the expected value.

FIG. 14 shows examples of stress data tables for third embodiment.

FIG. 15 shows a configuration example of a computer system according to a fourth embodiment.

FIG. 16 is a block diagram illustrating a configuration example of a semiconductor device that conceptually illustrates LSIs related to the first to third embodiments.

FIG. 17 is a block diagram illustrating a configuration example of a server pertaining to a fourth embodiment that is conceptually illustrated.

### DETAILED DESCRIPTION

### First Embodiment

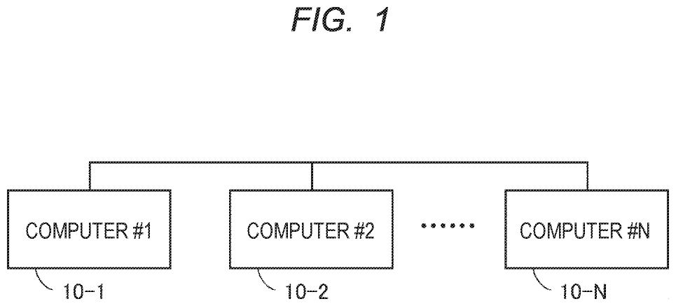

First, a configuration of computer system according to a present first embodiment will be described with reference to FIG. 1. As shown in FIG. 1, the computer system according to the present embodiment 1 includes a plurality of computers 10-1 to 10-N connected to each other, where N is a natural number of 2 or more. In the following drawings, for example, the computer 10-N may also be referred to as a computer #N. In addition, if it is not specified which computer 10-1 to 10-N is to be used hereinafter, it may be referred to as computer 10.

The method of connecting the plurality of computers 10-1 to 10-N is not essential to the present first embodiment, and any method may be used. The computer system is, for example, an in-vehicle system composed of a plurality of computers 10-1 to 10-N mounted on the same vehicle, but the present invention is not limited thereto. In the following description, it is assumed that the computers 10-1 to 10-N are simultaneously activated and simultaneously stopped as in the in-vehicle system, but the present invention is not limited thereto. The system administrator may arbitrarily set the computers 10-1 to 10-N to be individually activated and individually stopped.

In a computer system including a plurality of computers 10, as shown in FIG. 1, if a malicious attacker tampers data of the computer 10 or replaces the computer 10 itself with an illegal computer 10, the integrity and reliability of the entire computer system are impaired.

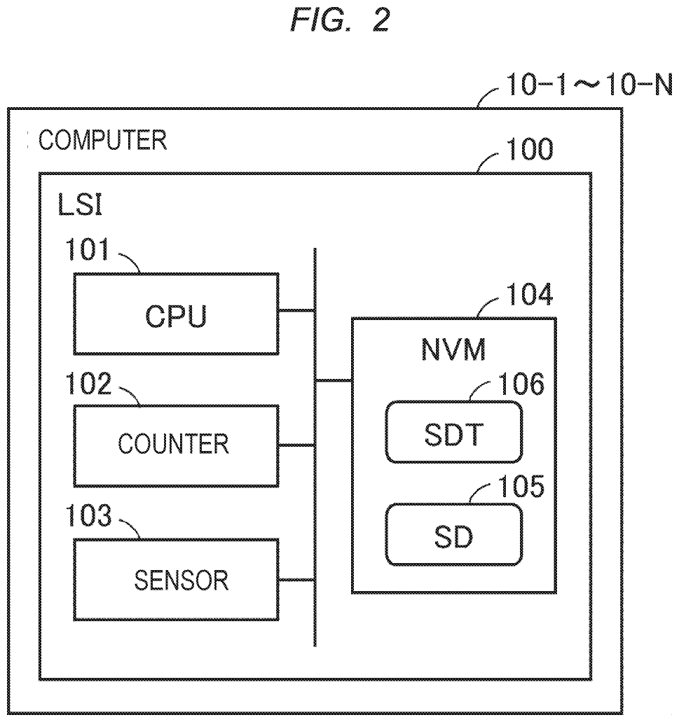

The present embodiment 1 focuses on stress data, which is irreversible data inherent in a LSI 100 (see FIG. 2 (to be described later)) provided in the computer 10, and detects abnormalities in the computer systems by using the stress data.

Next, referring to FIG. 2, the configuration of the computer 10 according to the present first embodiment will be described. As shown in FIG. 2, the computer 10 according to the present first embodiment includes a LSI 100 which is an exemplary semiconductor device. The LSI 100 includes a central processing unit (CPU) 101, a counter 102, a sensor 103, and a nonvolatile memory 104. These components are connected to each other via a bus. In FIG. 2, only the LSI 100 related to the present first embodiment is illustrated as the constituent elements of the computer 10, and the remaining constituent elements are omitted. Although FIG. 2 illustrates the common CPU 101 and the nonvolatile memory 104 and the like as components included in the LSI 100, the LSI100 may include various peripherals and the like depending on an application actually used.

The sensor 103 monitors the actual stress values of the stress to which its own LSI 100 is subjected during the operation of its own computer 10. For example, the sensor 103 monitors voltages (V) and environmental temperatures (T) supplied to the LSI 100 as actual stress values. The sensor 103 may monitor the temperature Tj of the LSI 100 itself as an actual stress value in addition to the voltage and the environmental temperature. In addition, it is preferable that the monitor by the sensor 103 be at intervals of 1 second or less, but there is no problem even further.

The counter 102 calculates the stress data, which is the data obtained by integrating the actual stress values, based on the actual stress values of its own LSI 100 monitored by the sensor 103. The method of calculating the stress data may be any method. For example, when the sensor 103 monitors the voltage (V) and the environmental temperature (T) as actual stress values, the stress data can be calculated by the following calculation method disclosed in Patent Document 1. Stress data ∝V̂n×exp(−Ea/kT), where n and Ea are coefficients and k is Boltzmann's constant.

The nonvolatile memory 104 stores stress data (SD: Stress Data) 105 and a stress data table (SDT: Stress Data Table) 106. The stress data 105 is stress data of its own LSI 100 calculated by the counter 102. The stress data table 106 is a table in which the stress data of the LSI 100 of each of the computers 10-1 to 10-N (including the stress data of the LSI 100 of its own computer 10) is written.

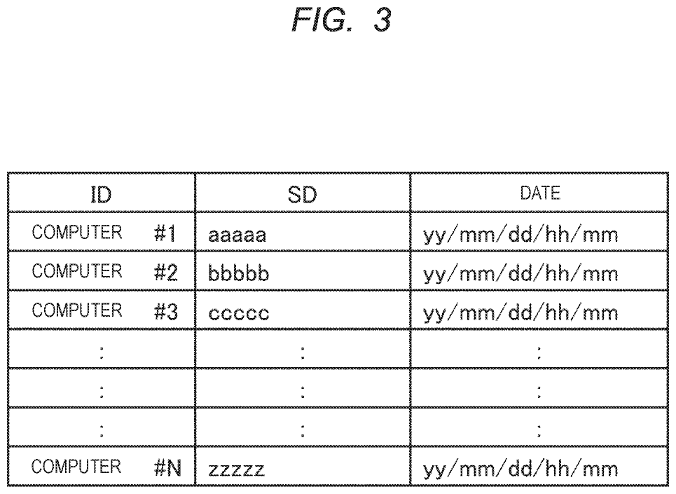

Referring now to FIG. 3, the stress data table 106 according to the present first embodiment will be described. As shown in FIG. 3, in the stress data table 106 according to the present first embodiment, the IDs of the computers 10, the stress data of the computers 10, and the dates of calculation of the stress data are written. However, the stress data table 106 in FIG. 3 is an example, and is not limited to this. In place of the stress data, an actual stress value used for calculating the stress data is written in the stress data table 106, and the calculation of the stress data may be performed at an arbitrary timing or may be performed externally as necessary.

When updating the stress data in the stress data table 106, the CPU 101 exchanges the stress data with another computer 10, for example, when the computer 10 is started up. That is, the CPU 101 transmits the ID of its own computer 10, the stress data stored as the stress data 105 in the nonvolatile memories 104 at that time, and the date when the stress data is calculated to the other computers 10. The CPU 101 also receives similar data in the other computers 10 from the other computers 10.

Then, the CPU 101 writes the stress data received from the other computers 10 in the stress data table 106 together with the IDs and the dates of the stress data of the other computers 10. On the other hand, with respect to the stress data of the own computer 10, the CPU 101 writes the stress data transmitted to the other computers 10 into the stress data table 106 together with the IDs and the dates.

Here, as an example of the timing of updating the stress data in the stress data table 106, the time of starting the computer 10 has been described, but the present invention is not limited to this. For example, the computer system may be a system which is subject to a restriction on a start-up time or the like, or may be a system which operates for 24 hours. Therefore, the update timing of the stress data in the stress data table 106 does not necessarily have to be at the time of starting the computer 10, and may be updated at regular intervals. The stress data in the stress data table 106 is generally considered to be reasonable to update once a day.

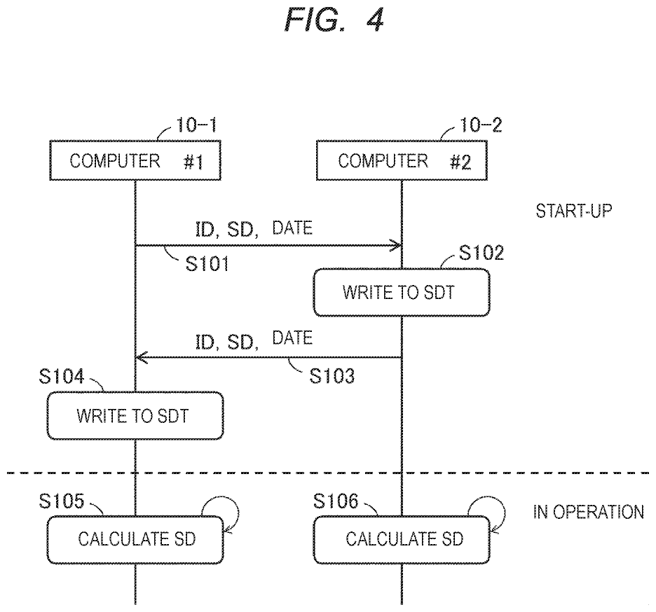

Hereinafter, the operation of the computer system according to the present first embodiment will be described. First, an operation of exchanging stress data between the computers 10 and an operation of calculating stress data by each computer 10 will be described with reference to FIG. 4. FIG. 4 shows an example in which the stress data is exchanged when the plurality of computers 10 are activated. While the computer 10 performs the operation of FIG. 4 with all other computers 10 at the time of startup, FIG. 4 shows a one-to-one operation between the computers 10-1 and 10-2 for the sake of simplification of description.

At the time of startup, the computer 10-1 transmits the stress data of the computer 10-1 stored as the stress data 105 in the nonvolatile memory 104 of the computer 10-1 to the computer 10-2 together with the ID and the date (step S101). The computer 10-2 writes the stress data of the computer 10-1 received from the computer 10-1 in the stress data table 106 of the computer 10-2 together with the ID and the date in step S102.

Next, the computer 10-2 transmits the stress data of the computer 10-2 stored as the stress data 105 in the nonvolatile memory 104 of the computer 10-2 to the computer 10-1 together with the ID and the date (step S103). In step S104, the computer 10-1 writes the stress data of the computer 10-2 received from the computer 10-2 into the stress data table 106 of the computer 10-1 together with the ID and the date.

As for the stress data of the computer 10-1, the computer 10-1 writes the stress data transmitted to the computer 10-2 in the step S101 into the stress data table 106 of the computer 10-1 together with the ID and the date. For the stress data of the computer 10-2, the computer 10-2 writes the stress data transmitted to the computer 10-1 at the step S103 to the stress data table 106 of the computer 10-2 along with the ID and date. In addition, the computers 10-1 and 10-2 may be configured to exchange the stress data first and then write the stress data in view of the relationship between the communication time and the write time. That is, first, step S101 and 5103 may be executed, and then step S102 and 5104 may be executed.

During the normal operation thereafter, the computer 10-1 always calculates stress data, and writes the calculated stress data in the nonvolatile memory 104 of the computer 10-1 as the stress data 105 (step S105). The computer 10-2 constantly calculates the stress data, and writes the calculated stress data as the stress data 105 in the nonvolatile memory 104 of the computer 10-2 (step S106).

Although FIG. 4 shows an example in which the computers 10-1 to 10-N are simultaneously activated and simultaneously stopped, in the case where the computers 10-1 to 10-N are individually activated and individually stopped, the computer 10 may perform the operation of FIG. 4 only with the other computers 10 that are being operated at the time of activation.

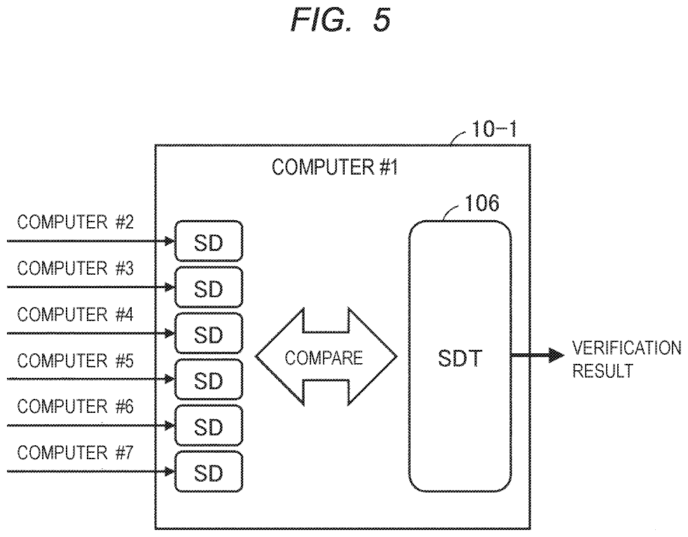

Next, the operation of verifying the stress data will be described with reference to FIG. 5. Although the verification of the stress data is performed in all the computers 10, FIG. 5 shows an operation in which the computer 10-1 verifies the stress data. FIG. 5 shows an example in which computers 10-2 to 10-7 exist as computers 10 other than the computer 10-1.

The computer 10-1 transmits the stress data of the computer 10-1, which the computer 10-1 has transmitted to the computers 10-2 to 10-7 most recently, to the computers 10-2 to 10-7 again. This operation is also performed by the computers 10-2 to 10-7. At this time, there is no restriction on the order in which the computers 10-1 to 10-7 operate. However, depending on the computer system, the computer 10 serving as the master may first perform the above operation.

Therefore, as shown in FIG. 5, the computer 10-1 receives the stress data of the computers 10-2 to 10-7 received most recently from the computers 10-2 to 10-7 again from the computers 10-2 to 10-7.

The computer 10-1 verifies whether the stress data of the computers 10-2 to 10-7 received again match the stress data of the computers 10-2 to 10-7 written in the stress data table 106 of the computer 10-1 or not. At this time, for example, if the value of the stress data to be compared is within the range of ±1% to 10%, it may be determined that the stress data coincide with each other. The computer 10-1 transmits the verification result to all the computers 10-2 to 10-7.

The computer 10-1 determines that the computer system is abnormal and notifies the system administrator, the user, or the like if the number of computers 10 whose stress data do not match is equal to or larger than the threshold value. As this notification method, it is conceivable that a screen for notifying the system abnormality is displayed on a display unit (not shown) of the computer 10-1, but the present invention is not limited thereto.

As a method of judging the system abnormality, a plurality of methods are conceivable, such as a method of judging the system abnormality when the threshold value is set to 1 and even one computer 10 whose stress data does not match occurs, and a method of judging the system abnormality by a majority vote (i.e., judging the system abnormality when the number of computers 10 whose stress data does not match is larger). For example, in the case where the computer system is a completely closed system or in the case where the security requirement is high, it is considered desirable to determine that the system is abnormal when at least one computer 10 having inconsistent stress data has occurred. On the other hand, when the computer system is a huge and open system, another threshold value other than 1 may be used as the threshold value of the system abnormality.

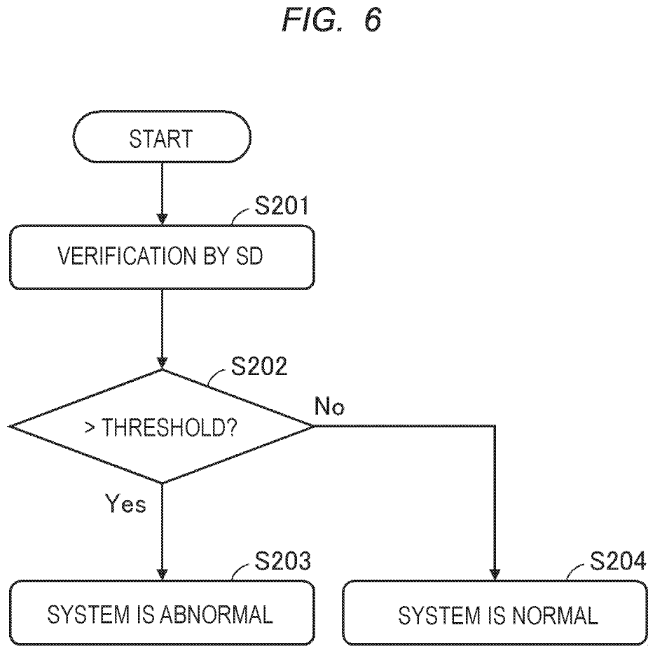

Next, the processing flow of FIG. 5 will be described with reference to FIG. 6. Although FIG. 6 is a flow performed by each of the computers 10-1 to 10-7, a flow in the case where the computer 10-1 is a processing subject will be described below.

As shown in FIG. 6, the computer 10-1 receives the stress data of the computers 10-2 to 10-7 received from the computers 10-2 to 10-7 immediately by the computer 10-1 again from the computers 10-2 to 10-7. Then, the computer 10-1 verifies whether or not the stress data of the computers 10-2 to 10-7 received again does not match the stress data of the computers 10-2 to 10-7 written in the stress data table 106 of the computer 10-1 (step S201). The computer 10-1 transmits the verification result to all the computers 10-2 to 10-7.

Next, the computer 10-1 compares the number of computers 10 in which the stress data is inconsistent with the number of thresholds in step S202. If the number is less than the threshold value, the computer 10-1 determines that the computer system is normal (step S204), and continues the operation as it is. On the other hand, if the number is equal to or larger than the threshold value, the computer 10-1 determines that the computer system is abnormal (step S203), and notifies the system administrator, the user, and the like to that effect.

In FIGS. 5 and 6, the verification of the stress data has been described as being performed by all of the plurality of computers 10, but the present invention is not limited thereto. Only at least one highly reliable computer 10 among the plurality of computers 10 may be configured to perform the verification of the stress data and transmit the verification result to the other computer 10.

As described above, according to the present first embodiment, each of the plurality of computers 10 calculates the effect data of its own computer 10, acquires the stress data of the other computer 10 from the other computer 10, and writes the stress data in the stress data table 106. In this manner, the stress data is shared by the plurality of computers 10.

Further, at least one computer 10 among the plurality of computers 10 reacquires the stress data of the other computer 10 acquired most recently from the other computer 10, verifies whether the reacquired stress data is inconsistent with the stress data of the other computer 10 written in the stress data table 106, and detects a system abnormality of the computer system based on the verification result.

As a result, even if a malicious attacker tampers with the data of the computer 10, it is possible to detect a system abnormality of the computer system caused by the tampering. Therefore, irreversible stress data inherent in the LSI 100 can be effectively used to detect system abnormalities in the computer system.

### Second Embodiment

If some parts of the system fail, replacing the parts and maintaining the system instead of replacing all of the systems is a very common maintenance. For example, in a computer system including a plurality of computers 10, such as a first embodiment, when the computer 10 fails, the failed computer 10 is replaced to maintain the system. The present second embodiment provides several aspects suitable for replacing computer 10 in computer systems including a plurality of computers 10.

In a computer system that includes a plurality of computers 10, a method of identifying whether the computer 10 has been replaced properly by a legitimate computer 10 or by an unauthorized computer 10 with malicious intent is required.

Aspect 1 of the present second embodiment distinguishes whether it is an unauthorized replacement with an unauthorized computer 10 or not.

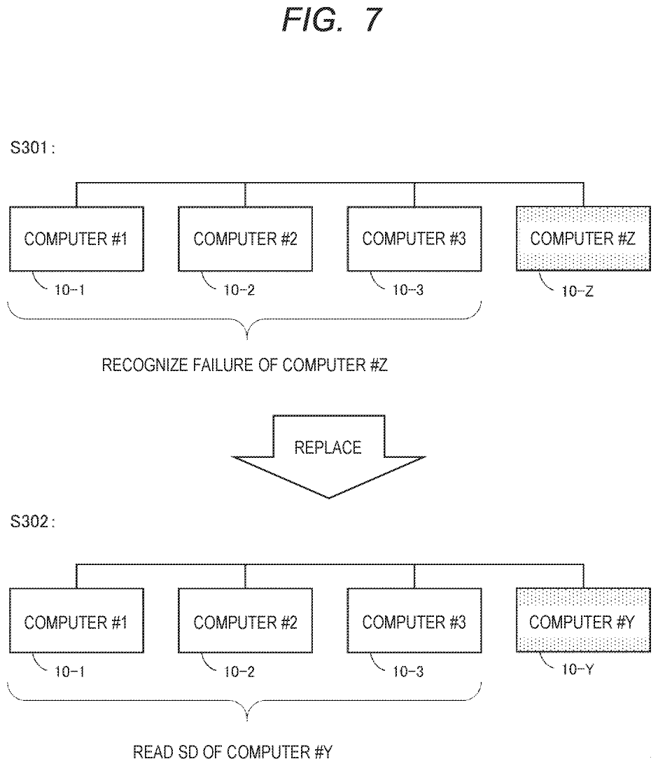

Referring to FIG. 7, computer systems according to first aspect of the present second embodiment will be described. FIG. shows an example in which the computer system includes a plurality of computers 10-1 to 10-3 and 10-Z, and a failure occurs in the computer 10-Z.

As shown in FIG. 7, the computers 10-1 to 10-3 recognize that a failure has occurred in the computer 10-Z in step S301. The method of recognizing the failure of the computer 10-Z may be any method. For example, in the verification shown in FIGS. 5 and 6, if the stress data of the computer 10-Z is inconsistent, it may be determined as a failure, or if the communication with the computer 10-Z is impossible, it may be determined as a failure.

After that, when the computer 10-Z is replaced by the computer 10-Y, the computers 10-1 to 10-3 read the stress data of the computer 10-Y from the replaced computer 10-Y (step S302). The method of reading the stress data of the computer 10-Y may be any method. For example, the stress data may be exchanged with the computer 10-Y by the operation shown in FIG. 4 when the computer 10-Y is first activated.

The computers 10-1 to 10-3 judge that the computer 10-Y is the legitimate computer 10 and has been properly exchanged if the stress data of the exchanged computer 10-Y is an initial value.

The computers 10-1 to 10-3 update the stress data table 106 after judging that the computer 10-Y has been properly replaced. At this time, in the stress data table 106, the stress data of the computer 10-Z before replacement may be erased and overwritten, or an entry of the computer 10-Y after replacement may be generated separately from the computer 10-Z before replacement, and the stress data of the computer 10-Y may be written in the entry. Which update method is selected can be arbitrarily selected depending on the memory resource of the computer 10.

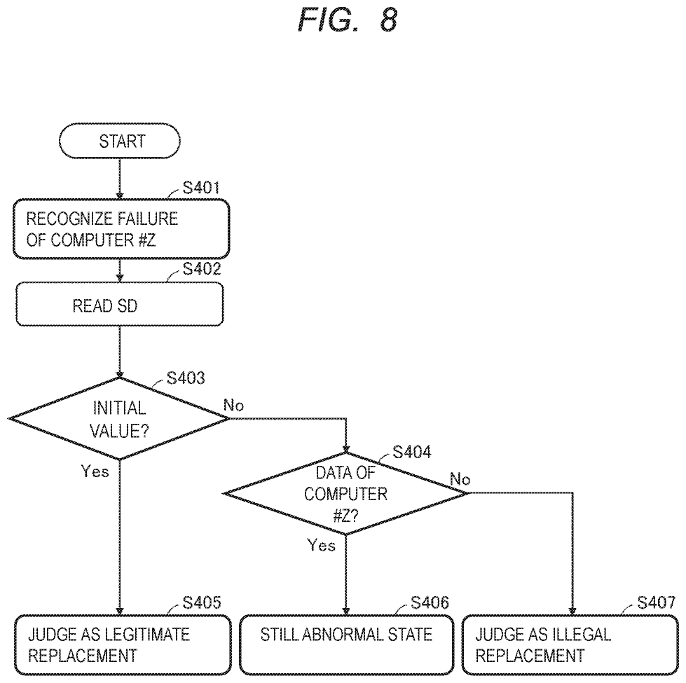

Next, with reference to FIG. 8, a processing flow in each computer 10 of FIG. 7 will be described. Although FIG. 8 is a flow performed by each of the computers 10-1 to 10-3, a flow in the case where the computer 10-1 is a processing subject will be described below.

As shown in FIG. 8, first, the computer 10-1 recognizes that a failure has occurred in the computer 10-Z in step S401. Then, the computer 10-1 reads out the stress data of the computer 10 at the location where the computer 10-Z is installed at any time thereafter (step S402).

Next, in step S403, the computer 10-1 checks whether the stress data read in step S402 is the default stress data or not. If the initial value is the initial value, the computer 10-1 determines that the computer 10-Z has been legitimately replaced with the normal computer 10 (here, the computer 10-Y) (step S405). Then, the computer 10-1 updates the stress data table 106.

On the other hand, if the initial value is not the initial value, the computer 10-1 next checks whether or not the stress data read in step S402 is the stress data of the computer 10-Z prior to replacement written in the stress data table 106 of the computer 10-1 (step S404). If the stress data is the stress data of the computer 10-Z prior to the replacement, the computer 10-1 determines that the replacement has not been performed yet and the computer system remains in the system abnormal state (step S406). On the other hand, if the stress data is not the stress data of the computer 10-Z before replacement, the computer 10-1 determines that the replaced computer 10 is the illegally replaced non-authorized computer 10 in step S407.

As described above, according to the first aspect of the present second embodiment, when any of the plurality of computers 10 is replaced, the computer 10 other than the replaced computer 10 reads the stress data of the computer 10 after replacement, and if the read stress data is neither the initial value nor the stress data of the computer 10 before replacement, it is determined that the replace computer 10 is an unauthorized computer 10 and is an unauthorized replacement.

Thus, when the computer 10 is replaced, it can be determined whether the replacement is an illegal replacement with a malicious and unauthorized computer 10 or not. Therefore, even if a malicious attacker replaces the computer 10 itself with an unauthorized computer 10, it can be determined that the replacement is unauthorized. In addition, an illegal replacement such as a replacement of the computer 10 as a new one by the computer 10 as a used one can be recognized.

In the first aspect of the second embodiment, if the computer 10-Z is properly replaced with a used but legitimate computer 10-Y, the stress data of the computer 10-Y is not an initial value, and therefore, it is determined that the replacement by the computer 10-Y is illegal as shown in the step S407 of FIG. 8. A second aspect of the present embodiment 2 is to suppress erroneous determination of a legitimate exchange with the used but legitimate computer 10 as an illegal exchange. However, the second aspect of the present second embodiment may be applied when the computer 10 is replaced with a new computer 10.

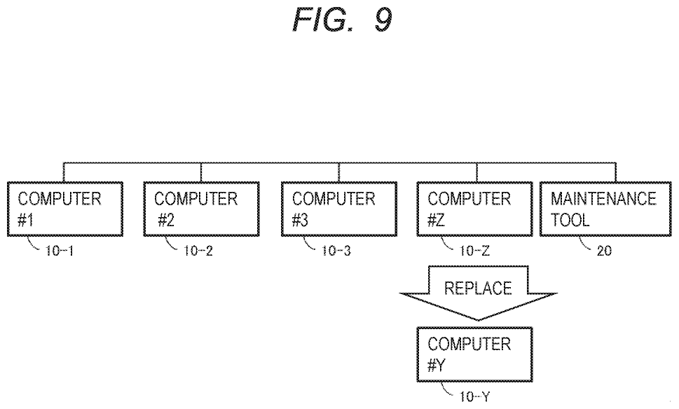

Referring to FIG. 9, a computer system according to the second aspect of the present second embodiment will be described. Similarly to FIG. 7, FIG. 9 shows an example in which the computer system includes a plurality of computers 10-1 to 10-3 and 10-Z, a failure occurs in the computer 10-Z, and the computer 10-Z is legitimately replaced with a normal computer 10-Y.

As shown in FIG. 9, the computer system according to the second aspect of the present second embodiment differs from the computer system according to the first aspect in that a maintenance tool 20 is added.

The maintenance tool 20 is an exemplary maintenance device for performing maintenance of the computer system. In the second embodiment, the maintenance tool 20 notifies each of the computers 10-1 to 10-3 that the computer 10-Z has been properly replaced by the normal computer 10-Y.

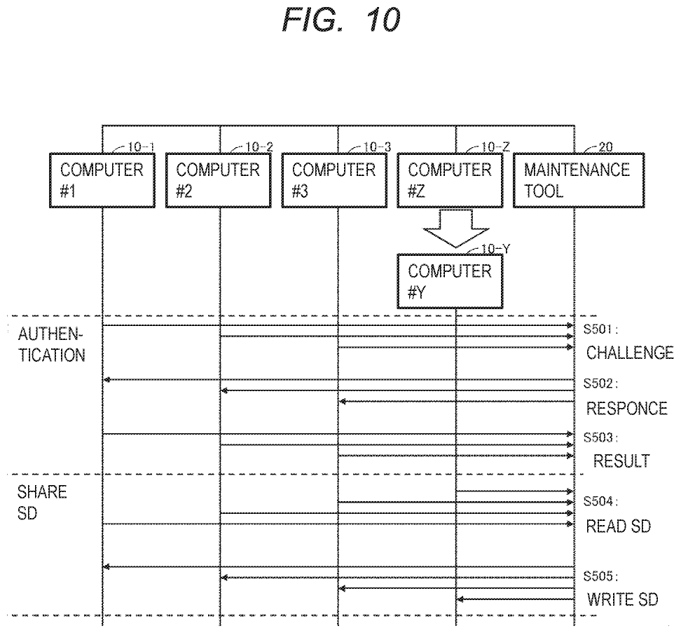

Hereinafter, referring to FIG. 10, a concrete operation when the computer 10 is legitimately replaced in the computer system according to the second aspect of the present embodiment 2 will be described. FIG. 10 shows the operation after the maintenance tool 20 notifies each of the computers 10-1 to 10-3 that the computer 10-Z has been properly replaced by the normal computer 10-Y.

As shown in FIG. 10, first, the computers 10-1 to 10-3 authenticate the maintenance tool 20 with the Root authorization via the maintenance tool 20, and after completion of the authentication, the computers 10-1 to 10-3 and 10-Z share the stress data.

Specifically, first, the computers 10-1 to 10-3 transmit challenges to the maintenance tool 20 (step S501), and the maintenance tool 20 transmits responses to the computers 10-1 to 10-3 (step S502). In step S503, the computers 10-1 to 10-3 authenticate the maintenance tool 20 using the challenges transmitted in step S501 and the responses received in step S502, and transmit the authentication results to the maintenance tool 20. In FIG. 10, a general challenge and response authentication method is used as the authentication method, but authentication may be performed by other authentication methods.

Next, the maintenance tool 20 reads the stress data stored as the stress data 105 in the nonvolatile memory 104 at that time from the computers 10-1 to 10-3 and 10-Y together with the IDs and the dates (step S504), and writes the read stress data into the stress data table 106 of each of the computers 10-1 to 10-3 and 10-Y together with the ID and the date (step S505). In the second aspect, a protocol for confirming whether the writing of the stress data is correctly completed or not is not an essential matter, and therefore, the description thereof is omitted.

As described above, according to the second aspect of the present second embodiment, when any of the plurality of computers 10 is legitimately replaced with the authorized computer 10, the maintenance tool 20 reads the stress data from the plurality of computers 10 including the replaced computer 10 after completion of the certification, and writes the read stress data to the stress data table 106 of each of the plurality of computers 10.

As a result, it is possible to suppress erroneous determination that the replacement with the legitimate computer 10 is an illegal replacement when the legitimate computer 10 is a used computer. In addition, the computer 10 can be safely replaced within the computer system.

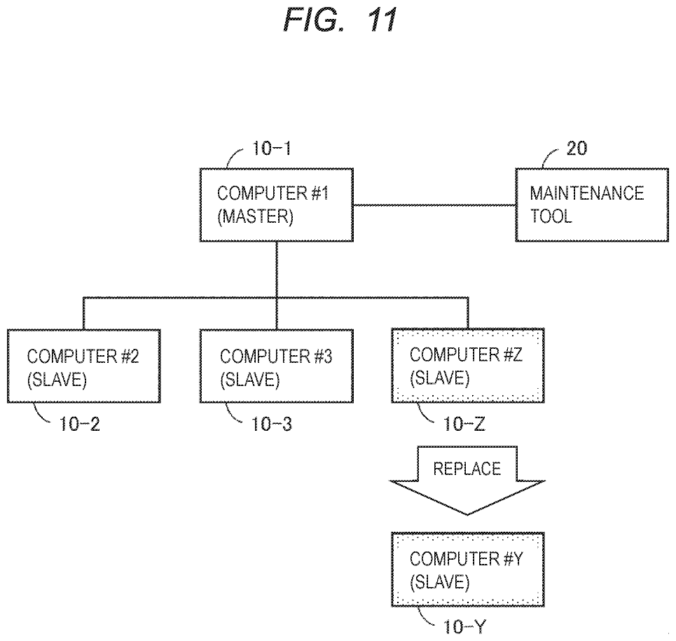

According to the second aspect of the second embodiment, authentication and writing of stress data was performed between the maintenance tool 20 and the plurality of computers 10. On the other hand, in a third aspect of the present embodiment 2, among the plurality of computers 10, the master computer 10 and the maintenance tool 20 authenticate each other, and the master computer 10 writes stress data to the slave computer 10. Referring to FIG. 11, a computer system according to a third aspect of the present second embodiment will be described. As shown in FIG. 11, in the computer system according to the third aspect of the present second embodiment, the computer 10-1 among the plurality of computers 10-1 to 10-3 and 10-Z is a master, and the other computers 10-2, 10-3 and 10-Z are slaves. Therefore, only the computer 10-1 is connected to the maintenance tool 20, and the computers 10-2, 10-3, and 10-Z are connected to the computer 10-1. FIG. 11 shows an example in which a failure occurs in the computer 10-Z and the computer 10-Z is properly replaced with a normal computer 10-Y, as in FIG. 7.

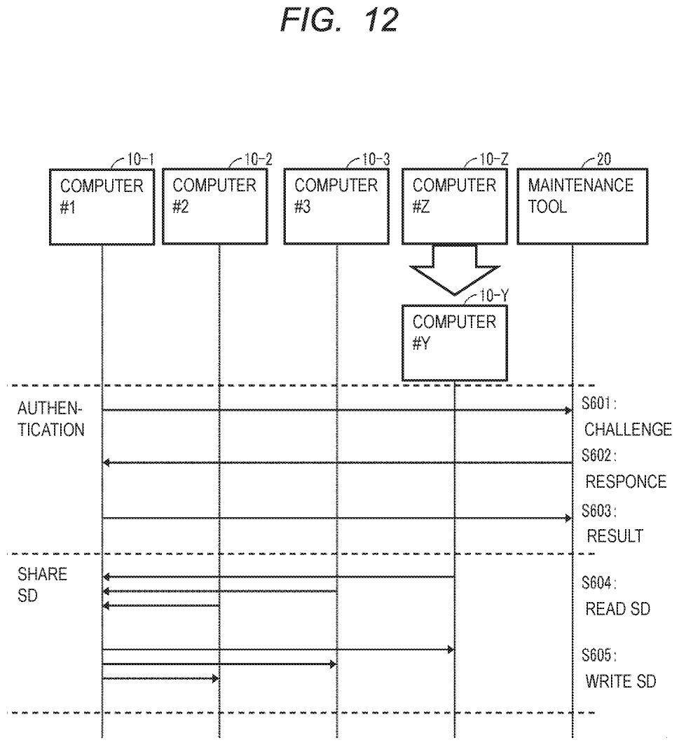

Hereinafter, referring to FIG. 12, a concrete operation when the computer 10 is legitimately replaced in the computer system according to the third aspect of the present second embodiment will be described. FIG. 12 shows the operation after the maintenance tool 20 notifies the master computer 10-1 that the computer 10-Z has been properly replaced with the normal computer 10-Y.

As shown in FIG. 12, first, the computer 10-1 serving as the master performs authentication of the maintenance tool 20 with the Root authorization via the maintenance tool 20, and after completion of the authentication, the computers 10-1 to 10-3 and 10-Z share the stress data. However, the present invention is not limited thereto, and the computer 10-1 serving as the master may authenticate the computer 10-2, 10-3, 10-Z serving as the slave at the same time as the authentication with the maintenance tool 20.

Specifically, first, the computer 10-1 serving as the master transmits a challenge to the maintenance tool 20 (step S601), and the maintenance tool 20 transmits a response to the computer 10-1 (step S602). In step S603, the computer 10-1 authenticates the maintenance tool 20 using the challenge transmitted in step S601 and the response received in step S602, and transmits the authentication result to the maintenance tool 20. Also in the third aspect, authentication may be performed by an authentication method other than the challenge and response authentication method.

Next, the master computer 10-1 reads the stress data stored as the stress data 105 in the nonvolatile memories 104 at that time from the slaves 10-2, 10-3, and 10-Y together with the IDs and dates (step S604). Then, the computer 10-1 writes the read stress data and the stress data of the computer 10-1 into the stress data table 106 of each of the computers 10-2, 10-3, and 10-Y together with the IDs and dates, and also writes them into the stress data table 106 of the computer 10-1 (step S605). Also in the third aspect, a protocol for confirming whether or not the writing of the stress data is correctly completed is omitted.

As described above, according to the third aspect of the present second embodiment, when any of the plurality of computers 10 is legitimately exchanged with the authorized computer 10, the master computer 10 reads the stress data from the plurality of slave computers 10 including the exchanged computer 10 after completion of the certification, writes the read stress data and its own stress data to the stress data table 106 of each of the plurality of slave computers 10, and writes the stress data and its own stress data to its own stress data table 106.

As a result, it is possible to suppress erroneous determination that the replacement with the legitimate computer 10 is an illegal replacement when the legitimate computer 10 is properly replaced although it is used. In addition, the computer 10 can be safely replaced within the computer system.

In a computer system comprising a plurality of computers 10 of a fourth aspect of the second embodiment, if a maintenance worker becomes a malicious attacker, for example, the stress data of a used computer 10 may be falsified and replaced by a new one. In the fourth aspect of the present embodiment 2, when the computer 10 is replaced, whether the stress data of the replaced computer 10 is tampered with the initial values is confirmed by using the calibration compensation coefficients.

The computer system according to the fourth aspect of the present second embodiment may have the same configuration as the computer system according to any one of the first to third aspects described above. That is, in the fourth embodiment, the maintenance tool 20 is not an indispensable component, and the presence or absence of the maintenance tool 20 may be arbitrary.

The stress of the LSI 100 fluctuates due to the manufacturing variation of the LSI 100. Therefore, when LSI 100 stress data is used for detecting a system abnormality or the like, calibration needs to be performed in order to exclude a variation factor peculiar to the LSI 100. Since the method of calibration is not essential to the fourth aspect, a detailed description thereof will be omitted, but an example thereof will be described below.

When the LSI 100 is manufactured and shipped, a plurality of measurements are performed, and the absolute value of the temperature and voltage is compared with the actual sensor value of the temperature and voltage derived from the sensor 103 to correct the actual sensor value. Calibration correction coefficients used for the correction are different for each LSI 100, and fluctuate when actual use is repeated.

Therefore, when the computer 10 is replaced by maintenance or the like, the initial calibration correction coefficient of the replaced computer 10 is shared with other computers 10 in the computer system. This sharing method may be any method. For example, the maintenance tool 20 may notify the other computer of the calibration correction coefficient, or the other computer 10 may acquire the calibration correction coefficient in the operation shown in FIG. 4 at the first start-up of the computer 10 after the replacement.

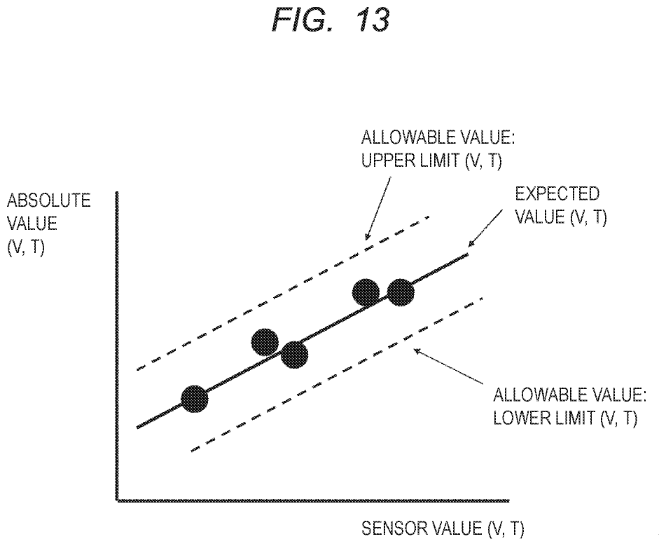

When the sensor value obtained by correcting the actual sensor value during normal operation by the initial calibration correction coefficient of the computer 10 after replacement deviates from the range of the expected value or the allowable value of the expected value, the other computer 10 determines that the stress data of the computer 10 after replacement has been falsified to the initial value, and the computer 10 after replacement is an irregular computer 10. FIG. 13 shows an example of an expected value of a sensor value and an allowable value of the expected value.

As described above, according to the fourth aspect of the present second embodiment, when any one of the plurality of computers 10 is replaced, the other computer 10 determines whether or not the stress data of the replaced computer 10 is falsified to the initial values by using the initial calibration correction coefficients of the replaced computer 10. As a result, the computer 10 after replacement can be judged to be an unauthorized replacement when the stress data is altered to the initial value and the computer 10 is an unauthorized computer.

### Third Embodiment

The present third embodiment realizes a mechanism in which a plurality of computers 10 share and verify stress data unique to a LSI 100 by using a block chain, using HASH (hashing) values of stress data, as shown in the above-mentioned first embodiment. Note that the block-chain technical itself is not the essence of present embodiment and therefore will not be referred to here.

The configuration of the computer system according to the present third embodiment may be the same as that of the first embodiment described above. That is, in the present third embodiment, the maintenance tool 20 is not an indispensable component, and the presence or absence of the maintenance tool 20 may be arbitrarily determined.

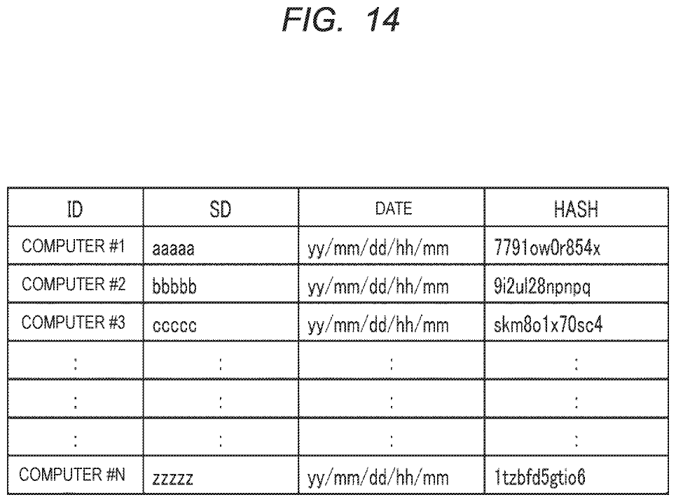

Referring now to FIG. 14, the stress data table 106 according to the present third embodiment will be described. As shown in FIG. 14, the stress data table 106 according to present third embodiment has HASH values added in addition to IDs, stress data, and dates. The HASH values are generally generated from the stress data, the date, and the encryption key, but may be generated only from the stress data and the date depending on the security strength of the computer system, the cryptographic operation performance, and the like. However, the stress data table 106 in FIG. 14 is an example, and is not limited to this. Instead of the stress data, an actual stress value used for calculating the stress data may be written in the stress data table 106, and the stress data may be calculated externally.

Hereinafter, the operation of the computer system according to the present third embodiment will be described. In the present third embodiment, the operation of either the following first operation example or second operation example can be realized. In the first operation example of the present third embodiment, the computer 10 exchanges stress data and HASH data with other computers 10 together with IDs and dates, for example, at the time of startup. Then, the computer 10 writes the stress data and HASH values of its own computer 10 and other computers 10 together with the IDs and dates in the stress data table 106 of its own computer 10, see FIG. 14.

When the stress data is verified, the computer 10 receives the stress data and the HASH values of the other computer 10 received most recently from the other computer 10 again from the other computer 10. Then, the computer 10 verifies whether the HASH value of the other computer 10 received again does not match the HASH value of the other computer 10 written in the stress data table 106 of its own computer 10. Alternatively, the computer 10 generates an expected value of the HASH value from the stress data of the other computer 10 written in the stress data table 106 of its own computer 10, and verifies whether or not the HASH value of the other computer 10 received again does not match the expected value of the generated HASH value. The expected value of the HASH value may be generated immediately before the stress data and the HASH value are received again from the other computer 10, or may be generated in advance before the stress data and the OOB value are received again. In the second operation example of the present third embodiment, the computer 10, upon startup, for example, exchanges stress data with other computers 10, as well as the first embodiment described above, with IDs and dates. The computer 10 writes the stress data of its own computer 10 and other computer 10 to the stress data table 106 of its computer 10, along with the ID and date, as in the first embodiment described above (see FIG. 3).

When the stress data is verified, the computer 10 receives the stress data of the other computer 10 received most recently from the other computer 10 again, and receives the HASH values of the stress data. Then, the computer 10 generates an expected value of the HASH value from the stress data of the other computer 10 written in the stress data table 106 of its own computer 10, and verifies whether or not the received HASH value of the other computer 10 does not match the expected value of the generated HASH value. The expected value of the HASH value may be generated immediately before receiving the HASH value from the other computer 10, or may be generated in advance before receiving the expected value.

As described above, according to the present third embodiment, when the stress data is verified, each of the plurality of computers 10 verifies the stress data based on the HASH values of the stress data of the other computers 10. As a result, as shown in the above-described first embodiment, a mechanism in which a plurality of computers 10 share and verify the stress data unique to the LSI100 by using the block chain can be realized by using the HASH values of the stress data.

### Fourth Embodiment

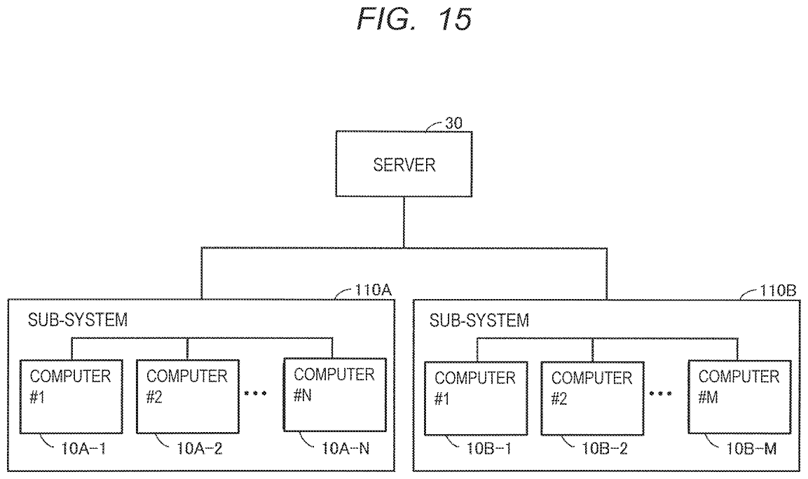

The computer system according to the present fourth embodiment is provided with a plurality of subsystems corresponding to the computer system according to the above-mentioned first embodiment. Referring to FIG. 15, the configuration of the computer system according to the present fourth embodiment will be described below. FIG. 15 shows an exemplary configuration in which two subsystems corresponding to the computer system according to the above-described first embodiment are provided.

As shown in FIG. 15, the computer system according to the present fourth embodiment includes two subsystems 110A and 110B corresponding to the computer system according to the first embodiment described above, and server 30 connected to the subsystems 110A and 110B. Subsystem 110A includes a plurality of interconnected computers 10A-1 to 10A-N (N is a natural number of 2 or more), and subsystem 110B includes a plurality of interconnected computers 10B-1 to 10B-M (M is a natural number of 2 or more). Hereinafter, when the computer 10A-1 to 10A-N is not specified, the computer 10A may be referred to as a computer 10A. Similarly, computers 10B-1 through 10B-M may be referred to as computer 10B.

In the first embodiment described above, each of the plurality of computers 10 verifies the stress data. In the present fourth embodiment, the server 30 includes a stress data table similar to the stress data table 106 provided by the computer 10, and performs verification of the stress data performed by the computer 10.

Specifically, the server 30 receives stress data from the plurality of computers 10A and the plurality of computers 10B, for example, at the time of startup, and writes the received stress data in the stress data table. When the stress data is calculated outside the computers 10A and 10B, the stress data may be received from an external device outside the computers 10A and 10B.

Then, when verifying the stress data, the server 30 receives the stress data received most recently from each of the plurality of computers 10A and 10B again, and verifies whether or not the stress data received again is inconsistent with the stress data written in the stress data table.

The server 30 transmits the verification result of the stress data of each of the plurality of computers 10A and the plurality of computers 10B to all of the plurality of computers 10A and the plurality of computers 10B.

In addition, if the number of computers 10A in which the stress data do not match in the subsystem 110A is equal to or larger than the threshold value, the server 30 determines that the subsystem 110A is a system abnormality, and notifies the system administrator, the user, or the like of the subsystems 110A and 110B to that effect. Further, if the number of computers 10B in which the stress data do not match within the subsystem 110B is equal to or larger than the threshold value, the server 30 determines that the subsystem 110B is a system abnormality, and notifies the system administrator, the user, or the like of the subsystems 110A and 110B of this fact.

Therefore, in the present fourth embodiment, the computers 10A and 10B need not include the stress data table similar to the stress data table 106 included in the computer 10.

As described above, according to the present fourth embodiment, the server 30 detect system anomalies of the subsystems 110A and 110B based on the stress data of the computers 10A and 10B in the subsystem 110A and 110B, respectively. Thus, even when the computer system includes a plurality of subsystems 110A and 110B, system abnormality of the plurality of subsystems 110A and 110B can be detected.

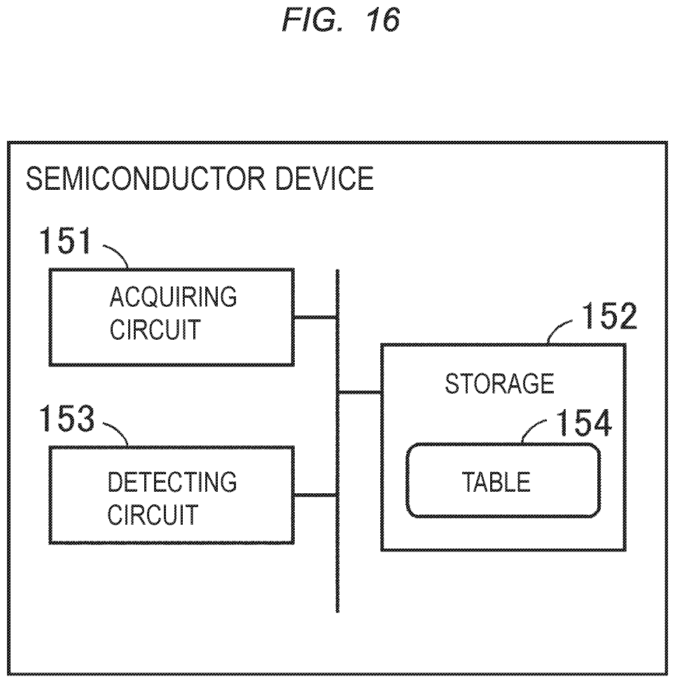

Next, referring to FIG. 16, a block diagram of a semiconductor device conceptually showing the LSI 100 according to the above-mentioned first to third embodiments is shown. This semiconductor device is one of a plurality of semiconductor device constituting the computer system. The semiconductor device shown in FIG. 16 includes an acquiring circuit 151, a storage 152, and a detecting circuit 153.

The acquiring circuit 151 acquires irreversible data unique to another semiconductor device. This data is, for example, stress data according to the embodiment described above. The acquiring circuit 151 may write the data of the other semiconductor device acquired most recently in the table 154. The semiconductor device shown in FIG. 16 may include a calculation circuit for calculating the data of its own semiconductor device. In this case, the calculation circuit is realized by, for example, the counter 102 and the sensor 103. Alternatively, the semiconductor device data may be calculated by an external device. The acquiring circuit 151 may acquire data of its own semiconductor device from a calculating circuit or an external device, or may write the acquired data in the table 154. The acquiring circuit 151 may acquire data of another semiconductor device from another semiconductor device or an external device. Further, the acquiring circuit 151 may exchange data with another semiconductor device at the time of activation of its own semiconductor device or at regular intervals. The acquiring circuit 151 is realized by, for example, the CPU 101. The storage 152 stores data of its own semiconductor device and the table 154. The storage 152 is realized by, for example, the nonvolatile memory 104.

The detecting circuit 153 reacquires the data of the other semiconductor device acquired most recently, verifies whether the reacquired data is inconsistent with the data of the other semiconductor device acquired most recently, and detects an anomaly of the computer system based on the verification result. When the data of the other semiconductor device acquired most recently is written in the table 154, the detecting circuit 153 may verify whether or not the re-acquired data does not coincide with the data of the other semiconductor device written in the table 154. In addition, the detecting circuit 153 may determine that the computer system is abnormal when the number of other semiconductor device whose data is inconsistent is equal to or larger than the threshold value. In addition, the detecting circuit 153 may perform the above-described verification using hash values of data of another semiconductor device. The detecting circuit 153 is realized by, for example, the CPU 101.

When any of a plurality of semiconductor device is replaced, the acquiring circuit 151 may acquire data from the replaced semiconductor device. The detecting circuit 153 may determine that the above-described replacement is an illegal replacement when the data of the semiconductor device after replacement is not the default values and is not the data of the semiconductor device before replacement written in the table 154.

The semiconductor device shown in FIG. 16 may further include an authenticating circuit (not shown) for authenticating the maintenance device upon receiving a notification from the maintenance device that any of the plurality of semiconductor devices has been properly replaced. In this instance, after the completion of the certification, the data of each of the plurality of semiconductor devices including the semiconductor device after the replacement may be written in the table 154 by the maintenance device.

The semiconductor device shown in FIG. 16 may further include an authenticating circuit (not shown) for authenticating the maintenance device when the master is notified from the maintenance device that any of a plurality of semiconductor devices has been properly replaced. In this instance, the acquiring circuit 151 may acquire the data of each of the plurality of semiconductor devices including the semiconductor device after the replacement after the completion of the certification, and may write the data of each of the plurality of semiconductor device to each of the plurality of semiconductor device tables 154.

When the semiconductor device shown in FIG. 16 includes a calculation circuit, the calculation circuit may correct the actual sensor value with the correction factor and calculate the data using the corrected sensor value. When any of a plurality of semiconductor devices is replaced, the acquiring circuit 151 may acquire the above-described correction coefficient from the replaced semiconductor device. The detecting circuit 153 may determine that the semiconductor device after replacement is in an irregular semiconductor device when the sensor value after correction corrected by the correction factor of the semiconductor device after replacement is out of the allowable range.

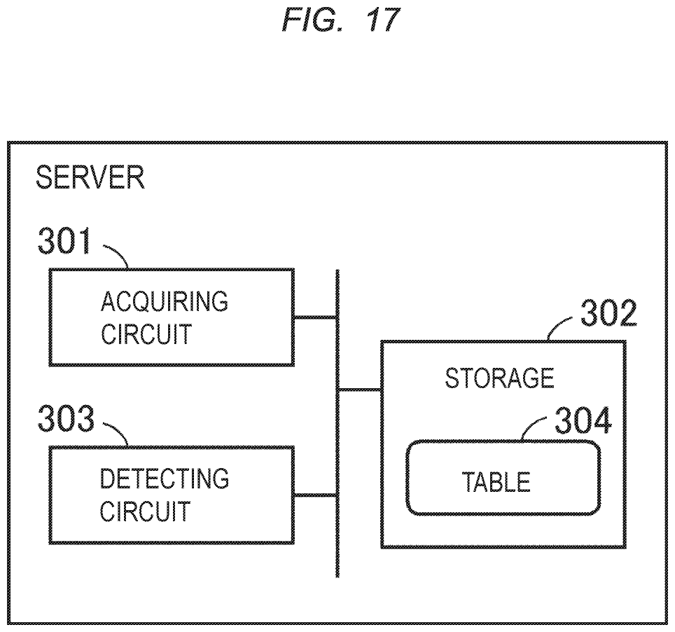

Referring now to FIG. 17, there is shown a diagram of a server conceptually showing the server 30 according to the fourth embodiment described above. The server are connected to a plurality of subsystems, each subsystem including a plurality of semiconductor devices. The server shown in FIG. 17 includes an acquiring circuit 301, a storage 302, and a detection circuit 303.

The acquiring circuit 301 acquires irreversible data unique to each semiconductor device of each of the plurality of subsystems. This data is, for example, stress data according to the embodiment described above. The acquiring circuit 301 may write the data of each of the plurality of semiconductor devices of each of the plurality of subsystems acquired most recently to the table 304. Further, the acquiring circuit 301 may acquire data at the time of activation of each semiconductor device of each of the plurality of subsystems or at regular intervals. The storage 302 stores a table 304.

The detecting circuit 303 reacquires the data of each of the plurality of semiconductor devices of each of the plurality of subsystems acquired most recently, verifies whether the data of the semiconductor device of the reacquired subsystem does not match the data of the semiconductor device acquired most recently, and detects an anomaly of the subsystem based on the verification result. When the data of each of the plurality of semiconductor devices of each of the plurality of subsystems acquired most recently is written in the table 304, the detecting circuit 303 may verify whether the data of the semiconductor device of the reacquired subsystem does not match the data of the semiconductor device written in the table 304. In addition, the detecting circuit 303 may determine that the sub-system is abnormal when the number of semiconductor device in which the data among the plurality of semiconductor device of the sub-system is inconsistent is equal to or larger than the threshold.

Note that each element shown in FIGS. 16 and 17 can be configured by a CPU, a memory, and other circuits in terms of hardware, and is realized by a program loaded into the memory in terms of software. Therefore, it is understood by those skilled in the art that these functional blocks can be realized in various forms by hardware alone, software alone, or a combination thereof, and the present invention is not limited to any of them.

Also, the programs described above may be stored and provided to a computer using various types of non-transitory computer readable media. Non-transitory computer-readable media include various types of tangible storage medium. Examples of non-transitory computer-readable media include magnetic recording media (e.g., flexible disks, magnetic tapes, hard disk drives), magneto-optical recording media (e.g., magneto-optical disks, CD-ROM(Compact Disc-Read Only Memory), CD-R(CD-Recordable), CD-R/W(CD-ReWritable, solid-state memories (e.g., masked ROM, PROM(Programmable ROM), EPROM(Erasable PROM, flash ROM, RAM (Random Access Memory)). The program may also be supplied to the computer by various types of transitory computer-readable media. Examples of transitory computer-readable media include electrical signals, optical signals, and electromagnetic waves. The transitory computer readable medium may provide the program to the computer via wired or wireless communication paths, such as electrical wires and optical fibers.

Although the invention made by the inventor has been specifically described based on the embodiment, the present invention is not limited to the embodiment already described, and it is needless to say that various modifications can be made without departing from the gist thereof.

For example, in the above-described embodiment, the stress data is given as an example of irreversible data inherent to semiconductor device, but the present invention is not limited thereto. The irreversible data unique to the semiconductor device may be, for example, data obtained by integrating the number of times of writing in the nonvolatile memories provided in the semiconductor device.

Part or all of the above-described embodiments and Embodiment may be described as the following additional statement, but the present invention is not limited thereto.

(Additional statement 1) A control method of semiconductor device of one of a plurality of semiconductor devices included in a computer system, the control method comprising steps of: acquiring irreversible data unique to one of the semiconductor devices; verifying the irreversible data unique to one of the semiconductor devices with previously acquired irreversible data unique to the one of the semiconductor devices; and detecting an abnormality of the computer system based on the verified result.

(Additional statement 2) A server connected to a plurality of subsystems each including a plurality of semiconductor devices, the server comprising: an acquiring circuit that acquires irreversible data unique to one of the plurality of semiconductor devices of one of the plurality of subsystems; and a detecting circuit that verifies whether the irreversible data of the one of the semiconductor devices is inconsistent with previously acquired irreversible data of the one of the semiconductor devices and detects an abnormality of the subsystem based on the verified result.

(Additional statement 3) The server according to additional statement 2, wherein the acquiring circuit stores the irreversible data of each of the plurality of semiconductor devices of each of the plurality of subsystems as a table, and the detecting circuit verifies whether the irreversible data of each of the semiconductor devices is inconsistent with previously acquired data of each of the semiconductor devices stored in the table, and detects an abnormality of the subsystem based on the verified result.

(Additional statement 4) The server according to additional statement 3, wherein the acquiring circuit acquires the irreversible data at startup of each of the plurality of semiconductor devices of each of the plurality of subsystems or at regular intervals.

(Additional statement 5) The server according to additional statement 3, wherein the detecting circuit determines that one of the subsystems is abnormal when the number of semiconductor devices of the plurality of semiconductor devices of the one of the subsystems each of which has the inconsistent irreversible data is greater than or equal to a threshold number.

(Additional statement 6) A computer system having a plurality of subsystems, each subsystem including a plurality of semiconductor devices and a server connected to the plurality of subsystems, the server comprising: an acquiring circuit that acquires irreversible data unique to each of the plurality of semiconductor devices of each of the plurality of subsystems; and a detecting circuit that verifies whether the irreversible data of each of the semiconductor devices is inconsistent with previously acquired irreversible data of each of the semiconductor device, and detects an abnormality of the subsystem based on the verified result.

(Additional statement 7) The computer system of additional statement 6, wherein the acquiring circuit stores the irreversible data of each of the plurality of semiconductor devices of each of the plurality of subsystems as a table, and the detecting circuit verifies whether the irreversible data of each of the semiconductor devices is inconsistent with previously acquired irreversible data stored as the table, and detects an abnormality of the subsystem based on the verified result.

(Additional statement 8) The computer system of additional statement 7, wherein the acquiring circuit acquires the irreversible data at the time of activation of each of the plurality of semiconductor devices of each of the plurality of subsystems or at regular intervals.

(Additional statement 9) The computer system according to additional statement 7, wherein the detecting circuit determines that the subsystem is abnormal when the number of semiconductor devices of the subsystem having the inconsistent irreversible data is greater than or equal to a threshold number.

(Additional statement 10) A method of controlling a server connected to a plurality of subsystems each including a plurality of semiconductor device, the method comprising steps of: acquiring irreversible data unique to each of the plurality of semiconductor devices of each of the plurality of subsystems, verifying whether the irreversible data of one of the semiconductor devices is inconsistent with previously acquired irreversible data of the one of the semiconductor devices, and detecting an abnormality of the subsystem based on the verified result.

What is claimed is:

1. A semiconductor device included in a computer system having a plurality of first semiconductor devices, the semiconductor device comprising:
an acquiring circuit that acquires irreversible data unique to a first semiconductor device; and
a detecting circuit that verifies whether the irreversible data from the first semiconductor device is inconsistent with previously acquired irreversible data from the first semiconductor device and detects an abnormality of the computer system based on the verified result.

2. The semiconductor device according to claim 1, further comprising:
a calculating circuit that calculates the irreversible data of its own semiconductor device,
wherein the acquiring circuit stores the irreversible data from the first semiconductor device as a table and verifies the irreversible data from the first semiconductor device with previously stored irreversible data as the table from the first semiconductor device.

3. The semiconductor device according to claim 2, wherein the acquiring circuit exchanges the irreversible data of its own semiconductor device with the first semiconductor device upon activation of its semiconductor device or at regular intervals.

4. The semiconductor device according to claim 2,
wherein the detecting circuit determines that the computer system is abnormal when the number of the first semiconductor devices each of which has the inconsistent irreversible data is greater than or equal to a predetermined number.

5. The semiconductor device according to claim 2,
wherein the acquiring circuit acquires the irreversible data from a replacement semiconductor device when the first semiconductor device is replaced by the replacement semiconductor device, and
wherein the detecting circuit determines that the replacement is an illegal replacement when the irreversible data of the replacement semiconductor device after replacement is neither a default value nor the irreversible data of the first semiconductor device stored as the table before replacement.

6. The semiconductor device according to claim 2, further comprising:
an authentication circuit that performs authentication of a maintenance device upon receipt of a notification from the maintenance device that the first semiconductor device has been properly replaced by a replacement semiconductor device,
wherein after completion of the authentication, the irreversible data of the replacement semiconductor device, is stored as the table by the maintenance device.

7. The semiconductor device according to claim 2, further comprising:
an authenticating circuit that performs authentication of a maintenance device when the semiconductor device is a master, and upon receiving a notification from the maintenance device that the first semiconductor device has been properly replaced,
wherein after completion of the authentication, the acquiring circuit acquires the irreversible data of each of the plurality of first semiconductor devices including the replacement semiconductor device, and writes the acquired irreversible data to the table of each of the plurality of semiconductor device.

8. The semiconductor device according to claim 2,
wherein the calculating circuit corrects an actual sensor value with a correction coefficient and calculates the irreversible data using the corrected sensor value,
wherein the acquiring circuit acquires the correction coefficient from a replacement semiconductor device after replacement when the first semiconductor device is replaced by the replacement semiconductor device, and
wherein the detecting circuit determines that the replacement semiconductor device after replacement is an illegal semiconductor device when the corrected sensor value corrected with the correction coefficient of the replacement semiconductor device after replacement is out of predetermined range.

9. The semiconductor device according to claim 2, wherein the detecting circuit verifies whether or not a hash value of irreversible the data of the first semiconductor device is inconsistent with a hash value of the irreversible data of the first semiconductor device stored as the table, and detects an abnormality of the computer system based on the verification result.

10. The semiconductor device according to claim 1, wherein the irreversible data is accumulated stress values of the first semiconductor device.

11. A semiconductor device included in a computer system having a plurality of first semiconductor device, the semiconductor device comprising:
an acquiring circuit that acquires irreversible data unique to each of the plurality of first semiconductor devices; and
a detecting circuit that detects an abnormality of the computer system based on the irreversible data.

12. A computer system including a plurality of semiconductor devices, each of the plurality of semiconductor devices comprising:
an acquiring circuit that acquires irreversible data unique to one of the semiconductor devices; and
a detecting circuit that verifies whether the irreversible data from the one of the semiconductor devices is inconsistent with previously acquired irreversible data from the one of the semiconductor devices and detects an abnormality of the computer system based on the verified result.

13. The computer system according to claim 12, wherein each of the plurality of semiconductor devices further comprises a calculating circuit that calculates the irreversible data of its own semiconductor device,
wherein the acquiring circuit stores the irreversible data from the one of the semiconductor devices as a table and verifies the irreversible data from the one of the semiconductor devices with previously stored irreversible data as the table from the one of the semiconductor devices.

14. A computer system according to claim 13, wherein the acquiring circuit exchanges the irreversible data with the one of the semiconductor devices upon activation of the semiconductor device or at regular intervals.

15. The computer system according to claim 13, wherein the detecting circuit determines that the computer system is abnormal if the number of the semiconductor devices each of which has the inconsistent irreversible data is greater than or equal to a predetermined number.

16. The computer system according to claim 13,
wherein the acquiring circuit acquires the irreversible data from a replacement semiconductor device when one of the semiconductor devices is replaced by the replacement semiconductor device, and
wherein the detecting circuit determines that the replacement is an illegal replacement when the irreversible data of the replacement semiconductor device after replacement is neither a default value nor the irreversible data of the one of the semiconductor devices before replacement stored as the table.

17. A computer system according to claim 13, further comprising:
a maintenance device that notifies each of the semiconductor devices of a legitimately replacement when one of the semiconductor devices has been legitimately replaced,
wherein the maintenance device, after completion of a certification of the maintenance device by one of the semiconductor devices other than the replacement semiconductor device, acquires the irreversible data of each of the semiconductor devices including the replacement semiconductor device, and stores the irreversible data as the table of each of the semiconductor devices.

18. The computer system according to claim 13, further comprising:
a maintenance device that notifies a semiconductor device serving as a master among the semiconductor devices of a legitimately replacement when one of the semiconductor devices is legitimately replaced,
wherein the acquiring circuit of the semiconductor device serving as the master acquires the irreversible data of each of the semiconductor devices including the replacement semiconductor device after completion of a certification of the maintenance device, and stores the irreversible data as the table of each of the semiconductor devices.

19. The computer system according to claim 13,
wherein the calculating circuit corrects an actual sensor value with a correction coefficient and calculates the irreversible data using the corrected sensor value,
wherein the acquiring circuit acquires the correction coefficient from a replacement semiconductor device after replacement when one of the semiconductor devices is replaced by the replacement semiconductor device, and
wherein the detecting circuit determines that the replacement semiconductor device after replacement is an illegal semiconductor device when the corrected sensor value corrected with the correction coefficient of the replacement semiconductor device after replacement is out of a predetermined range.

20. The computer system according to claim 13, wherein the detecting circuit verifies whether or not a hash value of the irreversible data of the one of the semiconductor devices is inconsistent with a hash value of the irreversible data of the one of the semiconductor device stored as the table, and detects an abnormality of the computer system based on the verification result.
